(19) United States
(12) Patent Application Publication
(10) Pub. No.: US 2005/0206848 A1
(43) Pub. Date: Sep. 22, 2005

(54) Projector with a compensator

(76) Inventor: Shi-Hwa Huang, Hsin-Tien City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/060,242

(22) Filed: Feb. 16, 2005

(30) Foreign Application Priority Data
Mar. 16, 2004 (TW) 093107005

(51) Int. Cl. G03B 21/14

(52) U.S. Cl. 353/31; 353/20

(57) ABSTRACT

A projector includes: a projection lens module; a kernel having at least a modulator and at least a polarization plate disposed between the projection lens module and the modulator; and a compensator disposed between and aligned with the projection lens module and the kernel along an optical path, and including a transparent plate that has a light entrance surface and a light exit surface opposite to the light entrance surface. The transparent plate has a thickness from the light entrance surface to the light exit surface along a direction of the optical path such that the thickness decreases from the first end toward the second end of the transparent plate.

### BACKGROUND OF THE INVENTION

1. Field of the Invention

The invention relates to a projector, more particularly to a projector with a compensator.

2. Description of the Related Art

As shown in FIG. 1, a conventional monochrome optical projector device 9 includes a light source (not shown), a prism-type polarizer 91 for polarizing light, a reflective type LCOS (Liquid Crystal On Silicon) modulator 92 for modulating the light from an object (not shown), and a lens module 93 for calibrating and projecting the modulated light. Utilizing projection principles, a light beam from the light source is first polarized, passed to the LCOS modulator 92 for modulation, and then reflected back to the prism-type polarizer 91 to filter the light beam, the result of which is only the desired light is passed through the prism-type polarizer 91 for subsequent adjustment and enlargement before projection from the lens module 93. In more complicated color optical projector devices, the light of an image is decomposed into red, green and blue lights for respective modulation. The red, green, and blue lights are then collected and recombined for subsequent projection using the lens module 93.

The prism-type polarizer 91 is typically formed by coating a plurality of thin films on SF57 glass, which is relatively expensive, followed by binding the coated SF57 glass to another glass. This not only incurs high manufacturing costs, but also is disadvantageous in that when angles of incident light from the light source become larger, the contrast of the image projected by the projector 9 is reduced, which results in lower luminance of projection. Therefore, as shown in FIG. 2, instead of the aforesaid prism-type polarizer 91, some manufacturers use a flat polarization plate 81 in an optical projector device 8. The polarization plate 81 includes a glass plate coated with a metal film which is etched to form a patterned surface for achieving a polarizing effect. In general, the polarization plate 81 is mounted inclinedly at a 45-degree angle relative to an optical path 80. The projector device 8 is less expensive than the aforesaid projector device 9, and exhibits a good contrast for lights with large incident angles. Hence, the projector device 8 is widely used in present-day applications.

Since the polarization plate 81 includes two parallel glass plates inclined at a 45-degree angle relative to the optical path 80, asymmetrical aberrations occur at the interface between air and the polarization plate 81 when light passes through the polarization plate 81. As shown in FIG. 2, light reflected from a point (A) of the surface of the LCOS modulator 82 has a cross-section at the polarization plate 81 different from that of the light reflected from a point (B) of the surface of the LCOS modulator 82, which can result in asymmetrical aberrations including spherical aberration, coma, astigmatism, field curvature, and distortion with respect to the optical path 80. Since the lens module 83 is disposed axially symmetrical with respect to the optical path 80, adjustment of the lens module 83 for projection of the light beams reflected from points (A) and (B) does not result in a clear image for both light beams. FIG. 3 illustrates the modulation transfer function (MTF) of the optical projector device 8, which represents the resolution of the projection of an object. The higher the percentage of the MTF, the clearer the projection. The results shown in FIG. 3 indicate that the projection of the projector device 8 is relatively poor. When the lens module 83 is adjusted for optimization of the light beam reflected from the point (A), the projection will be poor for the light beam reflected from the point (B). Similarly, when the lens module 83 is adjusted for optimization of the light beam reflected from the point (B), the projection will be poor for the light beam reflected from the point (A). Therefore, the conventional optical projector device 8 is unable to compensate for asymmetrical aberrations.

### SUMMARY OF THE INVENTION

Therefore, the main object of the present invention is to provide a projector that can overcome the aforesaid drawbacks associated with the prior art.

Accordingly, a projector of this invention comprises a light source that generates a light beam traveling along an optical path in the projector, a projection lens module, a kernel and a compensator.

The lens module defines a lens axis that is adapted to lie on the optical path.

The kernel is aligned with the projection lens along the optical path, and includes at least a modulator, and at least a polarization plate disposed between the projection lens module and the modulator and adapted to be inclined at a predetermined angle relative to the optical path.

The compensator is disposed between and is aligned with the projection lens module and the kernel along the optical path, and includes a transparent plate that has opposite first and second ends, a light entrance surface facing the kernel and extending from the first end to the second end, and a light exit surface facing the projection lens module and transverse to the optical path. The transparent plate has a thickness from the light entrance surface to the light exit surface along the optical path. The thickness of the transparent plate decreases gradually from the first end toward the second end of the transparent plate.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional monochrome optical projector device;

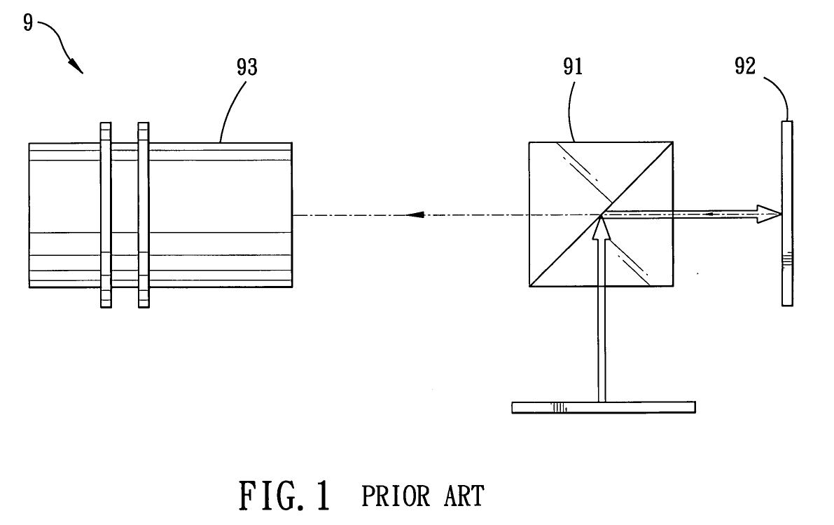

FIG. 2 is a schematic view of another conventional monochrome optical projector device;

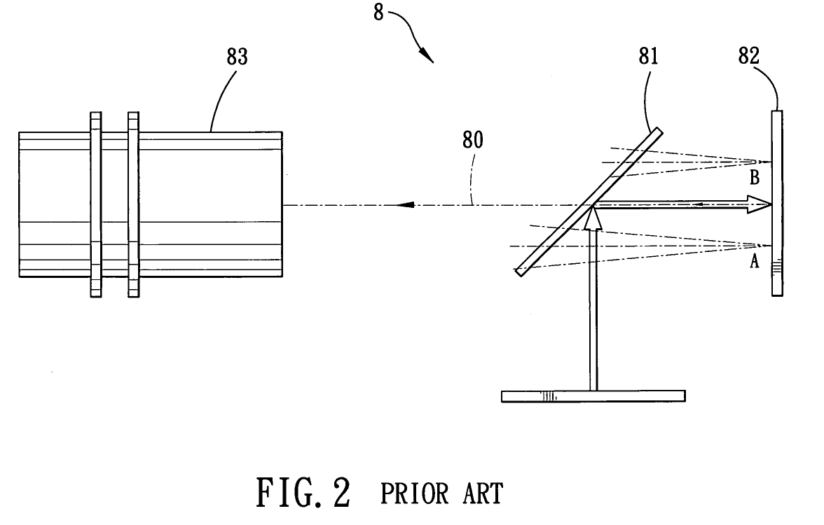

FIG. 3 is a graph of a modulation transform function relative to spatial frequency of the conventional monochrome optical projector device of FIG. 2;

FIG. 4 is an exploded perspective view of the first preferred embodiment of a projector with a compensator according to the present invention;

FIG. 5 is a schematic view of the first preferred embodiment;

FIG. 6 is a schematic view of the first preferred embodiment, illustrating how a polarization plate is compensated by a compensator of the projector;

FIG. 7 is a graph of a modulation transform function relative to spatial frequency of the first preferred embodiment; and

FIG. 8 is a schematic view of the second preferred embodiment.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

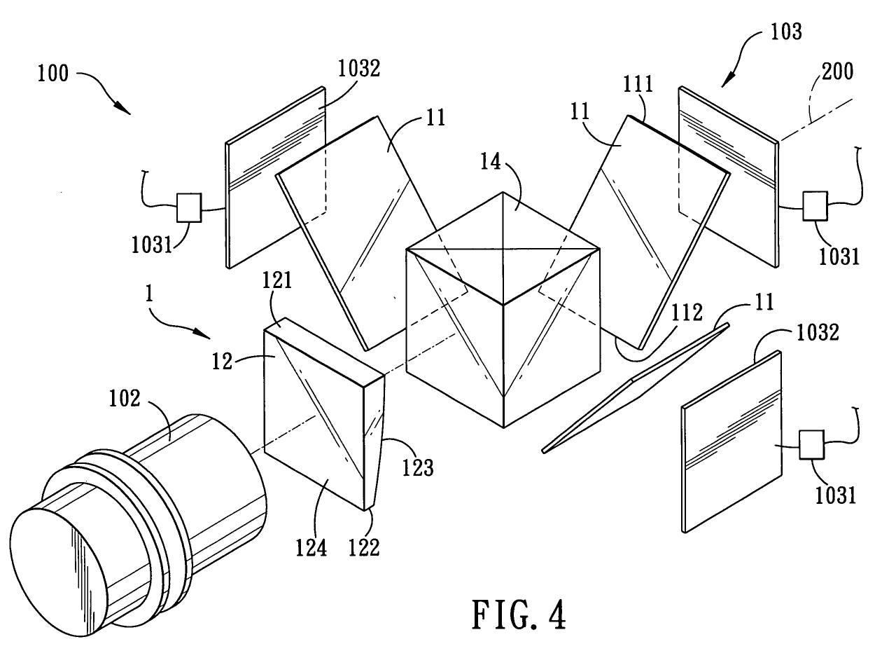

Referring to FIG. 4, the preferred embodiment of a projector 100 according to the present invention uses reflective-type Liquid Crystal On Silicon (LCOS) devices, and includes a light source (not shown) that can provide red, green and blue lights, a projection lens module 102 for projecting an image of an object (not shown), a lens unit (not shown) that is disposed between the light source and the projection lens module 102 for providing respective optical paths for the red, green and blue lights, a kernel 103, and a compensator 1. The lens unit is only used for filtering out monochrome lights with different respective wavelengths from the light source, and hence is not an essential component. For instance, when the projector 100 includes monochrome light emitting diodes (LEDs) with different respective wavelengths as the light source, the aforesaid lens unit can be dispensed with. This is well known to those skilled in the art, and is therefore not further detailed.

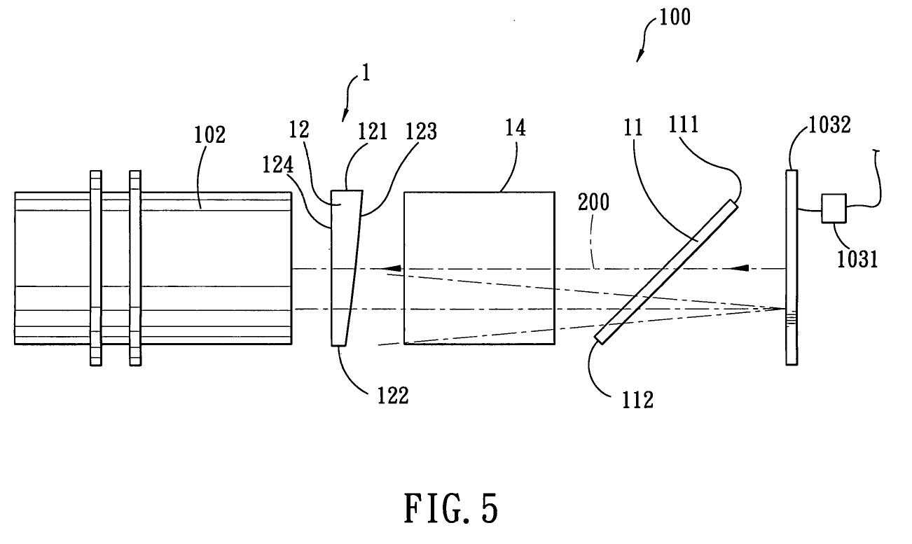

The kernel 103 includes three controllers 1031, three reflective-type LCOS modulators 1032, a prism (X-Cube) 14, and three polarization plates 11 for modulating the red, green and blue lights from the light source. Each of the LCOS modulators 1032 is connected to a respective one of the controllers 1031, and is disposed on a corresponding one of the optical paths for receiving control signals from the respective one of the controllers 1031 so as to perform light modulation. Since the structure for each pair of one of the polarization plates 11 and one of the LCOS modulators 1032 is the same, in the following description, only one of the optical paths (i.e., one of the red, green, and blue light optical paths) is described in greater detail with reference to FIG. 5. In FIG. 5, the optical path is indicated by reference numeral 200.

The controller 1031 of the kernel 103 is connected to an image processor (not shown) for receiving image data transmitted from the image processor so as to control activation of the reflective-type LCOS modulator 1032.

The compensator 1 is disposed on the optical path 200 which is modulated by the reflective-type LCOS modulator 1032, and includes a transparent plate 12. The polarization plate 11, the prism 14, and the transparent plate 12 are aligned with the projection lens module 102 along the optical path 200. It is worthy to note that although in this embodiment the compensator 12 is disposed between the prism 14 and the projection lens module 102, from the description below, those skilled in the art will appreciate that the compensator 12 can also be disposed between the transparent plate 11 and the prism 14, or between the transparent plate 11 and the reflective-type LCOS modulator 1032 to achieve the same compensation effect. Moreover, since the prism 14 is used to provide the functions of separating and combining the light beam from the light source, as well as changing of the optical paths, those skilled in the art should appreciated that other similar optical components can be used for replacement to provide the same functions. The prism 14 can be dispensed with when the projector 100 is a monochrome type optical projector.

The polarization plate 11 is a flat plate type of light splitter inclined at a 45-degree angle with respective to the optical path 200. The polarization plate 11 has a first end 111 disposed proximate to the reflective-type LCOS modulator 1032, and a second end 112 opposite to the first end 111 and disposed distal from the reflective-type LCOS modulator 1032.

The transparent plate 12 has opposite first and second ends 121, 122 that are respectively opposite to the first and second ends 111, 112 of the polarization plate 11 in a direction parallel to the optical path 200, a light entrance surface 123 facing the prism 14 and extending from the first end 121 to the second end 122, and a light exit surface 124 facing the projection lens module 102 and transverse to the optical path 200. The polarization plate 11 is inclined relative to the optical path 200 in such a manner that the first end 11 of the polarization plate 11 is more distal from the light exit surface 124 of the transparent plate 12 than the second end 112 of the polarization plate 11. The transparent plate 12 has a thickness between the light entrance surface 123 and the light exit surface 124 along the direction of the optical path 200. The thickness of the transparent plate 12 decreases gradually from the first end 121 toward the second end 122 of the transparent plate 12.

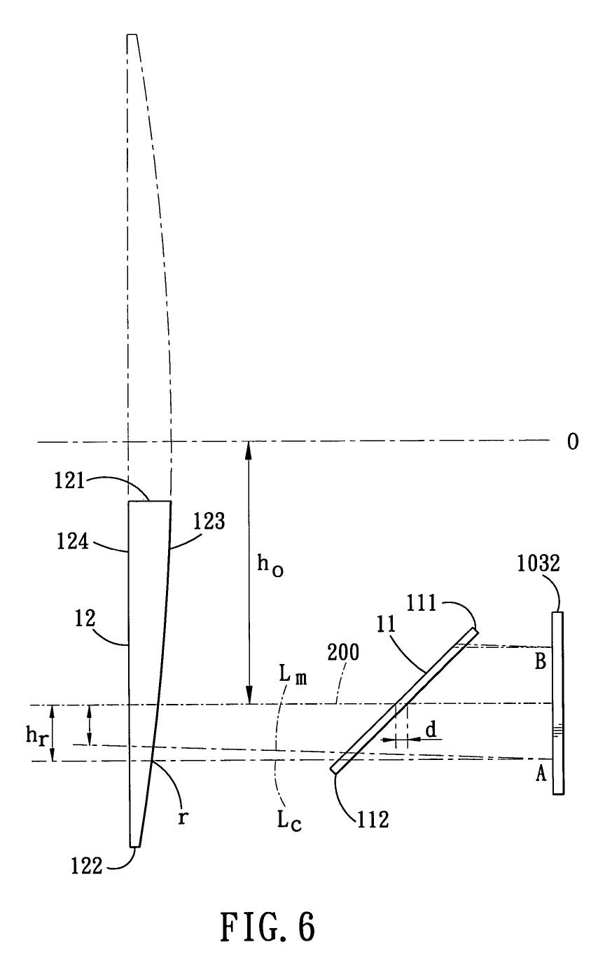

As shown in FIG. 6, the transparent plate 12 of the compensator 1 is preferably formed as a segment of a positive lens so that the light entrance surface 123 of the transparent plate 12 is curvedly toward the light exit surface 124 in a direction from the first end 121 to the second end 122 of the transparent plate 12 and so that it defines a virtual axis O which is parallel to the optical path 200 and which is spaced apart from the optical path 200 by a distance hₒ. The light beam reflected from the reflective-type LCOS modulator 1032 toward the polarization plate 11 can be split into a chief ray L_{c} and a marginal ray Lₘ. The distance between the optical path 200 and any incident point r on the light entrance surface 123 of the transparent plate 12 of the compensator 1, upon which the chief ray L_{c} of the light beam is incident, is defined as hᵣ. The distance hᵣ is less than hₒ, and is preferably much less than hₒ. Based on the paraxial theory and the principle of the asymmetrical aberration, the inventor found that the spherical aberration, coma, astigmatism, field curvature, and distortion of the polarization plate 11 can be best compensated by the compensator 1 when the following condition is satisfied:

$$\frac{{h}_{r}^{4}}{{h}_{o}^{3}} - \frac{d}{2} ≅ 0 ,$$

where d (see FIG. 6) is the thickness of the polarization plate 11 in millimeters along the optical path 200.

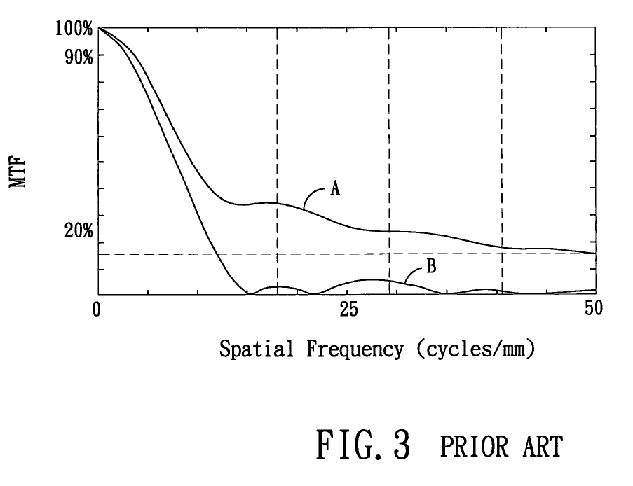

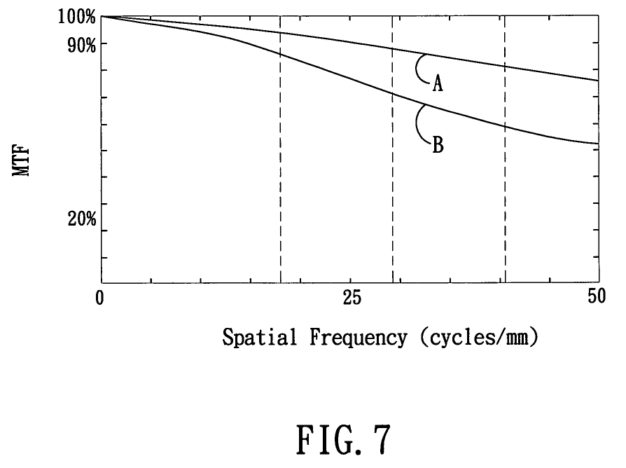

FIG. 7 is a graph of a modulation transform function with respect to the optical path 200. The result shows that adjustment of the projection lens module 102 of the projector 100 based on either point A or B (see FIG. 6), results in the projection of an object that is much better than that of the prior art (see FIG. 3) due to the inclusion of the compensator 1.

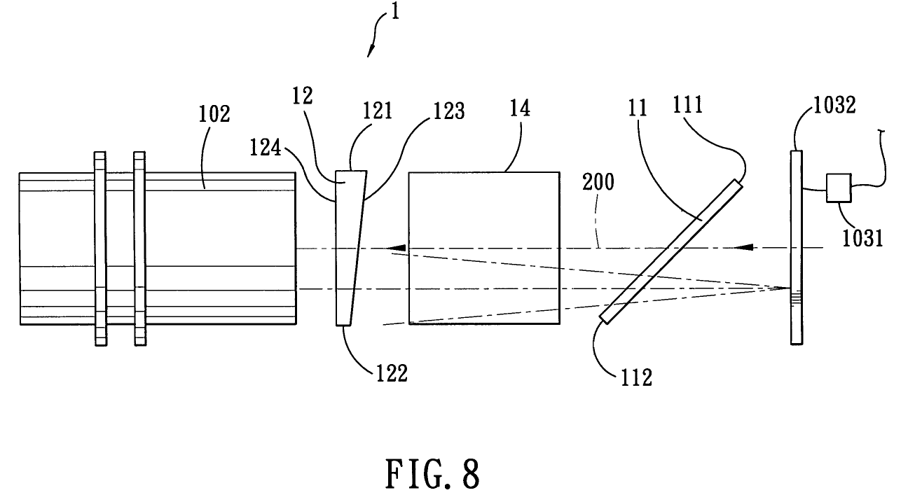

When hₒ>>hᵣ, the light entrance surface 123 of the transparent plate 12 can be assumed to be a flat plane. FIG. 8 illustrates the second preferred embodiment of the projector 100 according to this invention. The light entrance surface 123 of the transparent plate 12 of the compensator 1 is a flat plane, is not orthogonal to the optical path 200, and the intersection point between the light entrance surface 123 and the second end 122 is more distal from the reflective type LCOS modulator 1032 than the intersection point between the light entrance surface 123 and the first end 121. The second preferred embodiment has the advantages of a simpler manufacturing process and hence significantly reduced production costs, as well as a good compensation effect.

In sum, with the inclusion of the compensator 1 in the projector 100 of this invention, the aforesaid drawbacks associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A projector with a light source that generates a light beam traveling along an optical path in said projector, said projector comprising:
a projection lens module defining a lens axis that is adapted to lie on the optical path;
a kernel that is aligned with said projection lens module along the optical path and that includes at least a modulator, and at least a polarization plate disposed between said projection lens module and said modulator and adapted to be inclined at a predetermined angle relative to the optical path; and
a compensator disposed between and aligned with said projection lens module and said kernel along the optical path, and including a transparent plate that has opposite first and second ends, a light entrance surface facing said kernel and extending from said first end to said second end, and a light exit surface facing said projection lens module and transverse to the optical path, said transparent plate having a thickness from said light entrance surface to said light exit surface along a direction of the optical path, said thickness of said transparent plate decreasing gradually from said first end toward said second end of said transparent plate.

2. The projector as claimed in claim 1, wherein said transparent plate is formed as a segment of a positive lens, and defines a virtual axis which is adapted to be parallel to the optical path and which is adapted to be spaced apart from the optical path.

3. The projector as claimed in claim 2, wherein said predetermined angle is 45 degrees.

4. The projector as claimed in claim 3, wherein said polarization plate has opposite first and second ends that are respectively opposite to said first and second ends of said transparent plate in a direction parallel to the optical path, said polarization plate being inclined relative to the optical path in such a manner that said first end of said polarization plate is more distal from said light exit surface of said transparent plate than said second end of said polarization plate.

5. The projector as claimed in claim 3, wherein the distance between the virtual axis of said transparent plate and the optical path is defined as hₒ, the distance between the optical path and the incident point of the light beam on said light entrance surface of said transparent plate being defined as hᵣ, said light entrance surface of said transparent plate being curvedly toward said light exit surface in a direction from said first end to said second end of said transparent plate in such a manner that the following condition can be satisfied:
$$\frac{{h}_{r}^{4}}{{h}_{o}^{3}} - \frac{d}{2} ≅ 0 ,$$
where d is defined as the thickness of said polarization plate along the optical path.

6. The projector as claimed in claim 1, wherein said light entrance surface of said transparent plate is flat, and is inclined relative to the optical path.
